(19) United States
(12) Patent Application Publication
(10) Pub. No.: US 2022/0145138 A1
(43) Pub. Date: May 12, 2022

(54) PSA COMPOSITION HAVING HIGH SHEAR AND PEEL PROPERTIES

(71) Applicant: Avery Dennison Corporation, Glendale, CA (US)

(72) Inventors: Biao SHEN, Shanghai (CN); Hanpu LI, Suzhou City (CN); Yurun YANG, Shanghai (CN); Ke ZHAO, Shanghai (CN)

(21) Appl. No.: 17/433,399

(22) PCT Filed: Feb. 26, 2019
(86) PCT No.: PCT/CN2019/076120

§ 371 Date: Aug. 24, 2021

(51) Int. Cl. C09J 7/38; C08J 3/24; C08K 5/1515; C08K 5/29

(52) U.S. Cl. CPC C09J 7/385; C08J 3/24; C08K 5/1515; C08K 5/29; C09J 2433/00; C09J 2301/312; C09J 2301/162; C09J 2301/302; C09J 2203/334

(57) ABSTRACT

Provided herein is a pressure sensitive adhesive (PSA) that has balanced high shear and high peel strength. The PSA comprises a combination of epoxy and isocyanate crosslinkers and a polyacrylate tackifier.

### FIELD

The present disclosure relates generally to pressure-sensitive adhesives (PSAs), in particular, to PSAs with high shear and peel properties. This application also relates to labels containing the improved PSAs as well as to methods of producing the PSAs and the labels.

### BACKGROUND

PSAs are compositions known to provide adhesiveness or tack to various substrates when applied at room temperature. This adhesiveness can provide for instantaneous adhesion to the substrate when subjected to pressure. PSAs are generally easy to handle in solid form and have a long shelf-life, so they are widely used for the manufacture of, for example, self-adhesive labels. PSAs, due to their excellent mechanical features, are useful for automotive and machinery applications.

Good peel strength and excellent shear strength are often the competing features. Usually PSAs that show high peel strength have relatively poor shear strength. This is in part due to that PSAs having high peel strength often have high reactive state and crosslinking density, which results in poor anchorage, poor wetting property and low shear strength. This is undesirable as many applications require that the PSA product can be easily applied and repositioned after it is applied on the substrate. Further, many PSA applications also require reliable outdoor weathering resistance. The combination of these desired characteristics can only be achieved by using a PSA that possesses a specific balance of high shear and peel strength. The present invention solves this need.

### SUMMARY OF THE INVENTION

Provided herein are unique compositions of a pressure sensitive adhesive and methods for production thereof. The PSA comprises a novel combination of crosslinkers, which provides well-balanced properties of shear and peel, and a tackifier to further enhance the mechanical performance of the PSA. The tackifier may be an acrylate tackifier, for example, a polyacrylate tackifier.

In some embodiments, this disclosure provides a pressure sensitive adhesive comprising: a polyacrylate base polymer comprising acid groups and hydroxyl groups, a crosslinker package comprising: an isocyanate crosslinker, an epoxy crosslinker, and a polyacrylate tackifier. In some embodiments, the weight ratio of the polyacrylate tackifier to epoxy ranges from 35:1 to 131:1. In some embodiments, the weight ratio between the isocyanate crosslinker to the epoxy crosslinker ranges from 0.16:1 to 62:1.

In some embodiments, the pressure sensitive adhesive further comprises a non-polyacrylate tackifier. In some embodiments, the non-polyacrylate tackifier a terpene phenolic resin. In some embodiments, the epoxy has an epoxide equivalent weight (EEW) ranging from 70 g/eq to 220 g/eq.

In some embodiments, the amount of the isocyanate crosslinker is greater than the amount of epoxy. In some embodiments, the isocyanate crosslinker is present in an amount ranging from 0.1 wt. % to 10 wt %, based on total solid weight of the pressure sensitive adhesive. In some embodiments, the epoxy crosslinker is present in an amount ranging from 0.02 wt. % to 0.6 wt. %, based on total solid weight of the pressure sensitive adhesive. In some embodiments, the pressure sensitive adhesive demonstrates a 20 min 180 peel strength ranging from at least 8 N/inch on stainless steel, as measured according to FINAT-1 method. In some embodiments, the pressure sensitive adhesive demonstrates a static shear of at least 20 min, when tested on an area of 0.5 inch×0.5 inch at 80° C. and under a 2 kg load. In some embodiments, the polyacrylate tackifier has an acid value ranging from 5 mgKOH/g to 100 mgKOH/g. In some embodiments, the polyacrylate base polymer has a molecular weight ranging from 50,000 g/mol to 1,500,000 g/mol. In some embodiments, the acid value of the polyacrylate base polymer ranges from 2 mgKOH/g to 90 mgKOH/g. In some embodiments, the hydroxyl value of the polyacrylate base polymer ranges from 1 mgKOH/g to 50 mgKOH/g.

In some embodiments, the pressure sensitive adhesive comprises a polyacrylate tackifier that has a molecular weight that ranges from 10,000 g/mol to 280,000 g/mol. In some embodiments, the polyacrylate tackifier has a T_{g} that ranges from −30° C. to 40° C. In some embodiments, the polyacrylate tackifier is present in an amount ranging from 0.5 wt. % to 45 wt. % based on the total solid weight of the pressure sensitive adhesive. In some embodiments, the weight ratio of the polyacryate base polymer to the polyacrylate tackifier ranges from 4.6:1 to 80:1. In some embodiments, the acid value of the polyacrylate base polymer ranges from 10 mgKOH/g to 50 mgKOH/g; the OHV of the polyacrylate base polymer ranges from 5 mgKOH/g to 20 mgKOH/g; the isocyanate crosslinker is present in an amount ranging from 1 wt. % to 6 wt. % based on the total solid weight of the pressure sensitive adhesive; wherein the epoxy crosslinker is present in an amount ranging from 0.1 wt. % to 0.6 wt. % based on total solid weight of the pressure sensitive adhesive; wherein the polyacrylate tackifier is present in an amount ranging from 4 wt. % to 25 wt. % based on the total solid weight of the pressure sensitive adhesive; wherein the weight ratio of the polyacrylate tackifier to epoxy ranges from 35:1 to 131:1; wherein the pressure sensitive adhesive demonstrates a 20 min 180 peel strength of at least 12 N/inch on stainless steel, as measured according to FINAT-1 method, and wherein the pressure sensitive adhesive demonstrates a static shear at least 20 min, when tested on an area of 0.5 inch×0.5 inch at 80° C. and under a 2 kg load.

In some embodiments, the acid value of the polyacrylate base polymer ranges from 10 mgKOH/g to 50 mgKOH/g and the OHV of the polyacrylate base polymer ranges from 5 mgKOH/g to 20 mgKOH/g, the isocyanate crosslinker is present in an amount of 1 wt. % to 6 wt. % based on total solid weight of the pressure sensitive adhesive, the epoxy crosslinker is present in an amount ranging from 0.1 wt. % to 0.6 wt. % based on the total solid weight of the pressure sensitive adhesive, the polyacrylate tackifier is present in an amount ranging from 4 wt. % to 25 wt. % based on the total solid weight of the pressure sensitive adhesive, the weight ratio of the polyacrylate tackifier to epoxy ranges from 35:1 to 131:1, the polyacrylate tackifier has an acid value ranging from 50 mgKOH/g to 75 mgKOH/g, wherein the pressure sensitive adhesive demonstrates a 20 min 180 peel strength of at least 12 N/inch on stainless steel, as measured according to FINAT-1 method, and wherein the pressure sensitive adhesive demonstrates a static shear at least 20 min, when tested on an area of 0.5 inch×0.5 inch at 80° C. and under a 2 kg load.

In some embodiments, the acid value of the polyacrylate base polymer ranges from 10 mgKOH/g to 50 mgKOH/g and the OHV of the polyacrylate base polymer ranges from 5 mgKOH/g to 20 mgKOH/g, the isocyanate crosslinker is present in an amount ranging from 1 wt. % to 6 wt. % based on the total solid weight of the pressure sensitive adhesive, the epoxy crosslinker is present in an amount ranging from 0.1 wt. % to 0.6 wt. % based on the total solid weight of the pressure sensitive adhesive, the polyacrylate tackifier is present in an amount ranging from 4 wt. % to 25 wt. % based on the total solid weight of the pressure sensitive adhesive, and the polyacrylate tackifier has a molecular weight of 90,000 g/mol to 220,000 g/mol and has a T_{g} of −15° C. to −8° C.

In some embodiments, this disclosure provides a laminate composition comprising a liner layer and a pressure sensitive adhesive layer, wherein the pressure sensitive layer comprises the pressure sensitive adhesive. In some embodiments, the liner is an embossed liner. In some embodiments, the laminate composition comprises a facestock layer and a pressure sensitive adhesive layer. In some embodiments, the facestock layer is a film comprising one or more resins selected from the group consisting of polyester, ABS, polyacrylate, polycarbonate (PC), polyamide, polyimide (PI), polyamidoimide, polyacetal, polyphenylene oxide (PPO), polysulfone, polyethersulfone (PES), polyphenylene sulfide, polyether ether ketone (PEEK), polyetherimide (PEI), metallized polyethylene terephthalate (PET), polyvinyl fluoride (PVF), polyethylene ether (PEE), fluorinated ethylene propylene (FEP), polyurethane (PUR), liquid crystal polymers (LCPs, class of aromatic polyester), polyvinylidene fluoride (PVDF), aramid fibers, DIALAMY, (polymer alloys), polyethylene naphthalate (PEN), ethylene/tetrafluoroethylene, (E/TFE), polyphenyl sulfone (PPSU).

In some embodiments, the laminate further comprises a topcoat layer disposed on top of the facestock layer. In some embodiments, the laminate is disposed in the form of a flat layer having a thickness ranging from 8 μm to 80 μm. In some embodiments, this disclosure provides a label comprising the pressure sensitive adhesive of any of embodiments above, or the laminate composition as described above. In some embodiments, the disclosure provides a method for producing a pressure sensitive adhesive comprising: dissolving in a solvent a) a polycrylate base polymer; b) an isocyanate and an epoxy; and c) a polyacrylate tackifier to produce a pressure sensitive adhesive solution. In some embodiments, the polyacrylate tackifier has an acid value ranging from mgKOH/g to 100 mgKOH/g. In some embodiments, the solvent is selected from the group consisting of toluene, ethyl acetate, isopropanol, xylene, n-hexane, n-heptane, methyl cyclohexane, butyl acetate, acetone, butanone, and 2-Acetoxy-1-methoxypropane. In some embodiments, the acid value of the polyacrylate base polymer ranges from 2 mgKOH/g to 90 mgKOH/g. In some embodiments, the OHV of the polyacrylate base polymer ranges from 1 mgKOH/g to 50 mgKOH/g. In some embodiments, the polyacrylate tackifier has a molecular weight of lower than 280,000 g/mol. In some embodiments, the polyacrylate tackifier has a T_{g} higher than −30° C. In some embodiments, the acid value of the polyacrylate tackifier ranges from 5 mgKOH/g to 100 mgKOH/g. In some embodiments, the epoxide equivalent of the epoxy crosslinker ranges from 70 g/eq to 220 g/eq. In some embodiments, the method further comprises the step of coating a facestock with the PSA solution, and drying the pressure sensitive adhesive solution to produce a label.

In some embodiments, the method further comprises the step of coating a release liner with the pressure sensitive adhesive solution, drying the pressure sensitive adhesive solution on release liner to produce a dried PSA/liner composition, and applying the dried PSA/liner composition to a facestock to produce a label.

In some embodiments, this disclosure provides a pressure sensitive adhesive solution comprises: a polyacrylate base polymer solution, an isocyanate crosslinker, an epoxy crosslinker, a polyacrylate tackifier, and a solvent. In some embodiments, the solvent is selected from the group consisting of toluene, ethyl acetate, isopropanol, xylene, n-hexane, n-heptane, methyl cyclohexane, butyl acetate, acetone, butanone, and 2-Acetoxy-1-methoxypropane.

### DETAILED DESCRIPTION OF THE INVENTION

Current conventional pressure sensitive adhesives (PSAs) lack the optimal shear and peel performance that are desired in outdoor applications. Many of these adhesives were developed for applications where either high removability or high peel strength is preferred. Generally, these PSAs are unable to demonstrate both high static shear and high peel strength. In fact, many components used to contribute to improved adhesion (and therefore to increased peel strength) often have detrimental effects on the PSA's cohesiveness. Consequently, these PSA do not form good anchorage during transfer coat and have poor shear under challenging outdoor conditions.

Although PSAs using combinations of different crosslinkers have been reported in efforts to improve the performance of the PSAs, for example, as disclosed in U.S. Pat. Nos. 7,887,914B2; 9,828,533B2; and 8,828,539B2. The relationships of the crosslinkers in the PSA composition, e.g., the weight ratios and component concentrations, and the importance thereof were not developed or described in detail. Thus, the combination of performance properties of these PSAs still falls short of expectation. The inventors have now found that particular relationships of the crosslinkers, also in combination with the other components, provides for PSAs that do indeed possess the beneficial combination of performance features, balanced properties of high shear and peel, described above.

The present disclosure relates generally to pressure sensitive adhesives (PSAs) that possess synergistic combinations of performance characteristics, e.g,. both high shear strength and high peel strength. The disclosure relates to a pressure sensitive adhesive comprising a polyacrylate base polymer comprising acid groups and hydroxyl groups, a crosslinker package, and a polyacrylate tackifier. Importantly, the crosslinker package comprises a synergistic combination of crosslinkers that have been shown to provide for advantageous combinations of properties. In some cases, the crosslinker package comprises an isocyanate crosslinker and an epoxy crosslinker. The combination of these crosslinkers, in the particular amounts and ratios disclosed herein, and along with the polyacrylate base polymer and the polyacrylate tackifier, in the particular amounts and ratios disclosed herein, provides for the aforementioned combinations of performance characteristics.

### Polyacrylate Base Polymer

The polymer of the solvent-based PSA comprises a polyacrylate base polymer. Various acrylate polymers are known in the art.

In some embodiments, the polyacrylate base polymer or polyacrylate tackifier may comprise a single type of acrylate monomer, while in other cases, the polyacrylate base polymer or polyacrylate tackifier may comprise a combination of different acrylate monomers.

In some embodiments, the polyacrylate base polymer may comprise acrylate monomers that also include alkyl chains. These alkyl chains may vary widely, e.g., linear, branched, cyclical, aliphatic, aromatic, saturated, or unsaturated. The number of carbon atoms in the alkyl chain(s) of the acrylate monomer may vary, ranging from 1 to 20 carbon atoms, e.g., from 2 to 15, from 2 to 13, from 4 to 10, from 4 to 8 carbons. In preferred embodiments, these alkyl chains comprise no more than 20 carbon atoms, e.g., no more than 15 carbon atoms, no more than 12 carbon atoms, no more than 8 carbon atoms, no more than 6 carbon atoms, no more than 5 carbon atoms, or no more than 4 carbon atoms. In preferred embodiments these alkyl chains comprise greater than 1 carbon atom, e.g., greater than 1, greater than 3, greater than 4, or greater than 5 carbon atoms.

The average molecular weight of the polyacrylate base polymer may vary widely. In some cases, the average molecular weight may range from 50,000 g/mol to 1,500,000 g/mol, e.g., from 70,000 g/mol to 1,200,000 g/mol, from 100,000 g/mol to 1,000,000 g/mol, from 300,000 g/mol to 800,000 g/mol, from 400,000 g/mol to 700,000 g/mol, or about 600,000 g/mol. In terms of upper limits, the polyacrylate base polymer can have an average molecular weight of less than 1,500,000 g/mol, e.g., less than 800,000 g/mol, less than 600,000 g/mol. In terms of lower limits, the polyacrylate base polymer can have an average molecular weight of greater than 50,000 g/mol, e.g., greater than 100,000 g/mol, or less than 300,000 g/mol.

In some embodiments, the polyacrylate base polymer contains acid groups and/or hydroxyl groups. In some embodiments, the monomers that form the polyacrylate base polymer include acrylic acid monomers and/or acrylate ester monomers. In some embodiments, the monomers that form the polyacrylate base polymer further include monomer that contain a hydroxyl group (“hydroxyl group donor”) and the amount of which present in the polymer directly correlated with the hydroxyl value of the polyacrylate base polymer. Non-exemplary hydroxyl group donors include hydroxyethylacrylate (HEA), hydroxypropylacrylate (HPA) and hydroxybutylacrylate (HBA). The amount of the hydroxyl group donor may range from 0.3 wt. % to 3 wt. % based on the total weight of the monomers that form the polyacrylate base polymer, e.g., from 0.4 wt. % to 2 wt. %, or from 0.5 wt. % to 1 wt. %. In terms of upper limits, the amount of the hydroxyl group donor may be less than 3 wt. %, less than 2 wt. %, or less than 1 wt. %. In terms of lower limits, the amount of the hydroxyl group donor may be present in an amount that is greater than 0.3 wt. %, greater than 0.4 wt. % or greater than 0.5 wt. %.

In some cases, the amount of the acid groups in the polyacrylate base polymer is expressed by an acid value. The acid value of the polyacrylate base polymer is the mass of potassium hydroxide (KOH), in milligrams, that is required to neutralize one gram of the polyacrylate base polymer. In some embodiments, the acid value of the polyacrylate base polymer ranges from 2 mg KOH/g to 90 mg KOH/g, e.g., from 4 mg KOH/g to 75 mg KOH/g, from 5 mg KOH/g to 35 mg KOH/g, 4 mg KOH to 36 mg KOH, from 8 mg KOH/g to 75 mg KOH/g, from 10 mg KOH/g to 50 mg KOH/g, or about 30 mg KOH/g. In terms of upper limits, the acid value of the polyacrylate base polymer is less than 90 mg KOH/g, less than 80 mg KOH/g, less than 75 mg KOH/g, less than 50 mg KOH/g, or less than 40 mg KOH/g. In terms of lower limits, the acid value of the polyacrylate base polymer is greater than 2 mg KOH/g, greater than 4 mg KOH/g, greater than 10 mg KOH/g, greater than 20 mg KOH/g, or greater than 25 mg KOH/g.

In some embodiments, the amount of the hydroxyl groups present in the polyacrylate base polymer is expressed by a hydroxyl value. The hydroxyl value of the polyacrylate base polymer is the mass of potassium hydroxide (KOH), in milligrams, required to neutralize the acetic acid taken up on the acylation of one gram of the polyacrylate base polymer. In some embodiments, the hydroxyl value of the polyacrylate base polymer ranges from 1 mg KOH/g to 50 mg KOH/g, from 2 mg KOH/g to 50 mg KOH/g, from 5 mg KOH/g to 40 mg KOH/g, from 5 mg KOH/g to 20 mg KOH/g, or about 10 mg KOH/g. In terms of upper limits, the hydroxyl value of the polyacrylate base polymer is less than 50 mg KOH/g, less than 30 mg KOH/g, or less than 20 mg KOH/g. In terms of lower limits, the acid value of the polyacrylate base polymer is greater than 1 mg KOH/g, e.g., greater than 2 mg KOH/g, or greater than 5 mg KOH/g.

The inventors have found that these particular acid values (attributed to the presence of the hydroxyl groups) and hydroxyl values (attributed to the hydroxyl groups) contribute to the improvements in shear strength and peel strength. The hydroxyl groups in the polymer react with the isocyanate crosslinker and the carboxyl groups react with the epoxy crosslinker. As described below, crosslinking with epoxy and crosslinking with isocyanate can result in different crosslinking density, which can affect the static shear and peel strength of the PSA. Maintaining the acid values and hydroxyl values of the base polymer as claimed is useful for obtaining the PSA with well-balanced mechanical performance.

In preferred embodiments, the polyacrylate base polymer is not a block copolymer. A block copolymer is a copolymer formed with two or more monomers that cluster together and form blocks of repeating units. For example, a polymer made up of X and Y monomers joined together like: Y-Y-Y-Y-Y-X-X-X-X-X-Y-Y-Y-Y-Y-X-X-X-X-X- is a block copolymer where -Y-Y-Y-Y-Y- and -X-X-X-X-X- groups are the blocks. Although the polyacrylate base polymer of the invention may comprise more than one types monomers, these monomers are distributed evenly in the polymer chain and do not form blocks of repeating units.

The polyacrylate base polymer is present in an amount ranging from 60 wt. % to 99.9 wt. %, e.g., from 70 wt. % to 98 wt. %, from 72 wt. % to 95 wt. %, from 75 wt. % to 90 wt. %, e.g., about 79.2 wt. %, based on the total dry weight of the PSA. In terms of upper limits, the polyacrylate base polymer is present in an amount less than 99.9 wt. %, less than 98 wt. %, or less than 95 wt. %. In terms of lower limits, the polyacrylate base polymer is present in an amount greater than 60 wt. %, e.g., greater than 70 wt. %, or greater than 72 wt. %.

Suitable commercially available polyacrylate base polymers include, Y-1130, Y-2310, Y-1510, Y-1310, Y-1501, Y-1210, Y-2100 from YASUSA Chemical, BPS5375 from Toyo ink, Etrac7017B, Etarc77307, Etarac7709, Etarac7055 from Eternal, PS8249 and PS8245 from Sumei, Ulrta-Reclo 236A, NC-310 from Soken. In some embodiments, the polyacrylate base polymer is produced by polymerizing one or more monomers selected from the group consisting of butyl acrylate, 2-ethylhexyl acrylate (2-EHA), hydroxyethylacrylate (HEA), methyl acrylate, and acrylic acid. In some embodiments, the polyacrylate base polymer or acrylate tackifier (e.g., polyacrylate tackifier)acrylate tackifier (e.g., polyacrylate tackifier) do not comprise iso-butyl methyl acetate (IBMA), ethyl acrylate (EA), Vinylic monomers, or combinations thereof.

These polyacrylate base polymers are typically available in solution, for example, Y-1210 has a solid content about 36 wt. % and a solvent content about 64 wt. %.

### Crosslinker Package

The PSA of the present invention comprises a crosslinker package comprising an epoxy and an isocyanate. These crosslinkers functionally link one polymer chain to another.

Without being bound by theory, it is believed that epoxy crosslinker crosslinks polyacrylate base polymer and generates a higher crosslinking density than the isocyanate crosslinker does. Thus, PSAs having too high an amount of epoxy crosslinker may have an excessively high crosslinking density, which may lead to poor anchorage, e.g., low peel strength, when applied to substrate by a transfer coating. On the other hand, it has been discovered that increasing the amount of isocyanate crosslinker can increase pot life but will decrease cohesiveness. Thus, PSAs having too high an amount of isocyanate crosslinker may exhibit poor shear. Accordingly, the inventors have found that specific ratios of epoxy crosslinker to isocyanate crosslinker advantageously provide unexpected combinations of performance features. For example, as disclosed above, the weight ratio of the isocyanate crosslinker to the epoxy crosslinker ranges from 0.16 to 62, e.g., from 0.7 to 50, from 1 to 40, from 2.5 to 38, or from 5 to 35. In term of upper limits, the weight ratio of the isocyanate crosslinker to the epoxy crosslinker is less than 62, less than 50, less than 40, less than 38. In terms of lower limits, the weight ratio of the isocyanate crosslinker to the epoxy crosslinker is greater than 0.16, greater than 0.7, or greater than 1. Maintaining the proper ratio between the epoxy crosslinker and isocyanate crosslinker has been found to be beneficial for improving the cohesiveness of the PSA while maintaining good peel strength.

The PSA may comprise from 0.02 wt. % to 0.6 wt. % of the epoxy crosslinker, e.g., from 0.05 wt. % to 0.4 wt. %, from 0.08 wt. % to 0.3 wt. %, from 0.1 wt. % to 0.2 wt. %, or about 0.15 wt. % based on the total dry weight of the PSA. In terms of upper limits, the PSA comprises epoxy in an amount of less than 0.6 wt. %, less than 0.5 wt. %, less than 0.4 wt. %, or less than 0.3 wt. %, based on the total dry weight of the PSA. In terms of lower limits, the PSA comprises epoxy in an amount of greater than 0.02 wt. %, greater than 0.05 wt. %, greater than 0.08 wt. %, or greater than 0.1 wt. %, based on the total dry weight of the PSA.

In some embodiments, the epoxy crosslinker has an epoxide equivalent weight (EEW) ranging from 70 g/eq to 220 g/eq, e.g., from 80 g/eq to 200 g/eq, from 90 g/eq to 170 g/eq, from 100 g/eq to 140 g/eq, or about 113 g/eq. In terms of upper limits, the epoxy has an EEW less than 220 g/eq, less than 200 g/eq, less than 170 g/eq. In term of lower limits, the epoxy has an EEW greater than 70 g/eq, greater than 80 g/eq, greater than 90 g/eq or greater than 100 g/eq.

Suitable commercially available epoxy crosslinkers include, but are not limited to, Y-202 from YASUSA Chemical, 5-510 and S-610 from Synasia specialty chemical, BXX5983 from Toyoink. Suitable commercially available isocyanate crosslinkers include, but are not limited to, Desmodur L75, N75, N100, N3390 and Z4470 from Covestro; ISONATE 143L, PAPI580N from Dow, Takenate D-110 and D-262T from Mitsui. Additional examples of isocyanate includes, but not limited to, hexamethylene diisocyanate, isophorone diisocyanate, 1,4-cyclohexane bismethyl isocyanate, and 4,4-methylene-bis-cyclohexyl isocyanate.

The PSA also include an isocyanate resin as a crosslinker. The isocyanate resin may react with the hydroxyl group of the polyacrylate base polymer, as shown in the reaction scheme below.

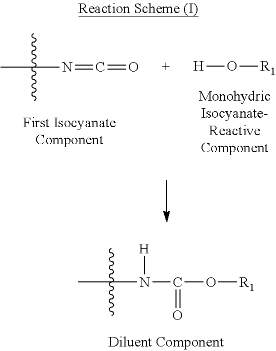

In some embodiments, the PSA comprises from 0.1 wt. % to 10 wt. % of the isocyanate crosslinker based on the total dry weight of the PSA, e.g., from 0.3 wt. % to 8 wt. %, from 0.5 wt. % to 7 wt. %, from 1 wt. % to 7 wt. %, from 1 wt. % to 6 wt. %, or from 2 wt. % to 5 wt. %. In terms of upper limits, the PSA comprises the isocyanate crosslinker in an amount of less than 10 wt. %, less than 8 wt. %, less than 7 wt. %, or less than 6 wt. %. In terms of lower limits, the PSA comprises the second crosslinker in an amount of greater than 0.1 wt. %, greater than 0.3 wt. %, greater than 0.5 wt. %, or greater than 1 wt. %.

It is believed that the NCO content of any isocyanate resin, which refers to the weight percent of the N═C═O functional group relative to the total resin, affects the rates and efficiency of the crosslinking reaction. As shown in Example IV, the inventors discovered that the presence of the isocyanate crosslinker, in addition to epoxy, could increase the mechanical performance of the PSA. In some embodiments, the second crosslinker is an isocyanate resin that has an NCO content ranging from 10 wt. % to 30 wt. % based on the total dry weight of the isocyanate resin, e.g., from 10 wt. % to 15 wt. %, from 10 wt. % to 20 wt. %, from 12 wt. % to 15 wt. %, from 15 wt. % to 25 wt. %, or from 15 wt. % to 30 wt. %. Isocyanate resins having NCO content higher than this range typically have low molecular weight and high volatility, and thus may be harmful to the environment or user. In terms of upper limits, the second crosslinker of the PSA has an NCO content that is less than 30 wt. %, less than 25 wt. %, or less than 20 wt. %. In terms of lower limits, the second crosslinker of the PSA has an NCO content that greater than 10 wt. %, greater than 12 wt. %, greater than 15 wt. % based on the total dry weight of the isocyanate resin.

Suitable, commercially available isocyanate resin crosslinkers include, but are not limited to, Desmodur L75, Desmodur N100, and Desmodur N3390 from Covestro.

In some embodiments, the PSA is essentially free of other crosslinkers that are not epoxy or isocyanate. By “essentially free”, it refers to that the PSA comprises less than 0.001 wt. % of other crosslinkers.

### Tackifier

The PSA disclosed herein also comprises a polyacrylate tackifier. In some embodiments, the PSA comprises one or more polyacrylate tackifiers. In general, the polyacrylate tackifier has a higher molecular weight than conventional tackifiers, e.g., rosin, which has been found to advantageously result in higher cohesiveness of the PSA. In addition, a polyacrylate tackifier is closer in structure to the base polymer than rosin. Thus, the polyacrylate tackifier can beneficially minimize the negative impact of conventional tackifiers on the cohesiveness of the PSA. In some cases, the average molecular weight may range from 10,000 g/mol to 280,000 g/mol, e.g., from 20,000 g/mol to 280,000 g/mol, from 30,000 g/mol to 250,000 g/mol, from 90,000 g/mol to 220,000 g/mol, from 100,000 g/mol to 200,000 g/mol or about 190,000 g/mol. In terms of upper limits, the polyacrylate base polymer can have an average molecular weight of less than 300,000 g/mol, e.g., less than 280,000 g/mol, less than 250,000 g/mol. In terms of lower limits, the polyacrylate base polymer can have an average molecular weight of greater than 10,000 g/mole, e.g., greater than 20,000 g/mol, greater than 30,000 g/mol, greater than 50,000 g/mol.

The polyacrylate tackifier in the PSA has relatively higher T_{g}. The high T_{g} also contributes to the increased cohesiveness of the PSA. However, surprisingly, the inventors have surprisingly found that tackifiers having a T_{g} that is too high, e.g., 43° C. or above, can have detrimental effect on cohesion properties of the PSA. See Table 2 in the EXAMPLES section. The T_{g} of the polyacrylate base tackifier used in the PSA typically ranges from −30° C. to 42° C. (including the endpoints), e.g., from −25° C. to 40° C., from −20° C. to 37° C., from −11° C. to 33° C. In terms of lower limits, the T_{g} of the polyacrylate base polymer is higher than −30° C., e.g., higher than −25° C., or higher than −15° C. In terms of upper limits, the T_{g} of the polyacrylate base polymer is lower than 40° C., e.g., lower than 37° C., or lower than 35° C.

The polyacrylate tackifier is present in the PSA in an amount ranging from 0.5 wt. % to 45 wt. %, e.g., from 1 wt. % to 30 wt. %, from 3 wt. % to 25 wt. %, from 4 wt. % to 21 wt. %, or about 10 wt.-20 wt. %, based on the total dry weight of the PSA. In terms of upper limits, the polyacrylate tackifier is present in an amount less than 45 wt. %, less than 30 wt. %, or less than 25 wt. %, based on the total solid weight of the PSA. In terms of lower limits, the polyacrylate tackifier is present in an amount greater than 0.5 wt. %, e.g., greater than 1 wt. %, greater than 3 wt. %, or greater than 4 wt. %.

The polyacrylate tackifier of the disclosure may have an acid value that ranges from 5 mgKOH/g to 100 mgKOH/g, e.g., 20 mgKOH/g to 90 mgKOH/g, 40 mgKOH/g to 80 mgKOH/g, 50 mgKOH/g to 75 mgKOH/g, or about 68 mgKOH/g. In terms of upper limits, the acid value of the acrylate tackifier (e.g., polyacrylate tackifier) is less than 100 mgKOH/g, less than 90 mgKOH/g, less than 80 mgKOH/g, or less than 75 mgKOH/g. In terms of lower limits, the acid value of the polyacrylate tackifier is greater than 5 mgKOH/g, greater than 20 mgKOH/g, greater than 40 mgKOH/g, or greater than 50 mgKOH/g.

Exemplary commercially available polyacrylate tackifiers that are suitable for use in the PSA disclosed herein include 109A, 247A from Henkel (Dusseldorf, Germany), Neocryl B-804 from DSM, BM141 from Pioneer, Y-1220 from YASUSA (JiaXing, P. Cr. China), Aroset 951000 from Ashland (China) Holding Company, Dura tack 180-225A, Dura tack 180-225A, Dura tack 180-225A 109A, Dura tack 180-225A 196A from Henkel (Dusseldorf, Germany).

In some embodiments, the PSA may comprise additional non-acrylate tackifier (e.g., non-polyacrylate tackifier) to boost the tack of the PSA. In some embodiments, the non-acrylate tackifier is a terpene phenolic resin. Non-limiting examples of phenolic resin that can be used includes SYLVARES™ TP96 (KRATON, Houston, Tex., USA). In some embodiments the non-acrylate tackifier is present in an amount of 0.5 wt. % to 30 wt. %, e.g., from 1 wt. % to 20 wt. %, from 1.5 wt. % to 15 wt. %, from 2 wt. % to 12 wt. %, or about 3 wt. %, based on the total dry weight of the PSA. In terms of upper limits, the non-acrylate tackifier is present in an amount less than 30 wt. %, less than 20 wt. %, or less than 15 wt. %, based on the total solid weight of the PSA. In terms of lower limits, the non-acrylate tackifier is present in an amount greater than 0.5 wt. %, e.g., greater than 1 wt. %, greater than 1.5 wt. %, or greater than 2 wt. %.

The tackifier in the PSA may increase tack and the crosslinker in the PSA may increase the cohesiveness. As discussed above, the tack (which can be measured by peel) and cohesiveness (which can be measured by shear) are often the competing features and it is difficult to have a PSA that have both high peel and high static shear. In particular, the epoxy linker can impart high cohesion to PSA, but may negatively affecting wetting and tack. Polyacrylate tackifiers can impart PSA good wetting properties. The inventors have found that by maintaining the weight ratio of the polyacrylate tackifier to the amount of epoxy in a particular range, the PSA can have balanced, optimal tack and excellent cohesiveness. In some embodiments, the weight ratio of the polyacrylate tackifier to the epoxy in the PSA may range from 35:1 to 131:1, e.g., from 45:1 to 110:1, from 51:1 to 96:1, from 55:1 to 90:1, or from 58:1 to 80:1. In terms of upper limits, the weight ratio of the acrylate tackifier to the total amount of crosslinkers may be less than 131:1, e.g., less than 110:1, less than 96:1, or less than 90:1. In terms of lower limits, the weight ratio of the tackifier to the total amount of crosslinkers may be greater than 35:1, e.g., greater than 45:1, greater than 51:1, or greater than 55:1.

In a particular, the PSA may comprise a polyacrylate base polymer, the acid value of which ranges from 10 mgKOH/g to 50 mgKOH/g and the OHV of which ranges from 5 mgKOH/g to 20 mgKOH/g. The PSA also comprises an isocyanate crosslinker that is present in an amount ranging from 1-6 wt. % based on total solid weight of the pressure sensitive adhesive. The PSA further comprises an epoxy crosslinker that is present in an amount ranging from 0.1 wt. % to 0.6 wt. % based on total solid weight of the pressure sensitive adhesive. The PSA further comprises a polyacrylate tackifier that is present in an amount ranging from 4 wt. % to 25 wt. % based on total solid weight of the pressure sensitive adhesive. The PSA, comprising the above-referenced components demonstrates a 20 min 180° peel strength of at least 12 N/inch on stainless steel, as measured according to FINAT-1 method, and a static shear greater than 20 min, when tested on an area of 0.5 inch×0.5 inch at 80° C. and under a 2 kg load. The “20 min 180° peel strength” refers to the test of peel strength by pulling the laminate comprising the PSA at 180° angle, 20 minutes after the laminate is applied to the stainless steel,

In another particular embodiment, the PSA comprises a polyacrylate base polymer, the acid value of which ranges from 10 mgKOH/g to 50 mgKOH/g and the OHV of which ranges from 5 mgKOH/g to 20 mgKOH/g. The PSA further comprises an isocyanate crosslinker that is present in an amount of 1 wt. % to 6 wt. % based on total solid weight of the pressure sensitive adhesive, and an epoxy crosslinker that is present in an amount ranging from 0.1 wt. % to 0.6 wt. % based on total solid weight of the pressure sensitive adhesive. The PSA further comprises a polyacrylate tackifier that is present in an amount ranging from 4 wt. % to 25 wt. % based on total solid weight of the pressure sensitive adhesive, and the polyacrylate tackifier has an acid value ranging from 50 mgKOH/g to 75 mgKOH/g. The weight ratio of the polyacrylate tackifier to epoxy ranges from 35:1 to 131:1, and the pressure sensitive adhesive demonstrates a 20 min 180° peel strength of at least 12 N/inch when tested on a stainless steel test panel. The test is performed according to the FINAT-1 (2019) method. The pressure sensitive adhesive comprising the above-referenced components demonstrates a static shear greater than 20 min, when tested on an area of 0.5 inch×0.5 inch at 80° C. and under a 2 kg load.

In another particular embodiment, the PSA comprises a polyacrylate base polymer, the acid value of which ranges from 10 mgKOH/g to 50 mgKOH/g and the OHV of which ranges from 5 mgKOH/g to 20 mgKOH/g. The PSA further comprises an isocyanate crosslinker that is present in an amount ranging from 1 wt. % to 6 wt. % based on total solid weight of the pressure sensitive adhesive, and an epoxy crosslinker that is present in an amount ranging from 0.1 wt. % to 0.6 wt. % based on total solid weight of the pressure sensitive adhesive, the weight ratio of the polyacrylate tackifier to epoxy ranges from 35:1 to 131:1 and a polyacrylate tackifier that is present in an amount ranging from 4 wt. % to 25 wt. % based on total solid weight of the pressure sensitive adhesive, and the polyacrylate tackifier has a molecular weight of 90,000 g/mol to 220,000 g/mol and has a T_{g} ranging from −15° C. to −8° C.

### Laminate Composition

The disclosure also provides a laminate composition that comprises any of the PSAs disclosed above. The laminate composition may comprise a facestock layer and an adhesive layer comprising the PSA as disclosed herein. In some cases, the laminate composition further comprises a topcoat layer disposed on the top of the facestock layer. In some cases, the laminate composition further comprises one or more primer layers and/or a liner, as further described below. The disclosure also contemplates labels that comprise the laminate compositions.

### Facestock Layer

The laminate composition may have one or more facestock layers. In one embodiment, from the perspective of looking downward to the substrate, the facestock layer is on the top surface of the label, exposed to the environment. In some embodiments, the facestock layer is configured to receive printable information, such as barcode or alphanumeric characters.

In some embodiments, the pressure sensitive adhesive is disposed in the form of a flat layer (optionally as a layer in the laminate composition). The flat layer has a thickness that ranges from 8 microns to 80 microns, e.g., from 12 microns to 70 microns, from 25 microns to 70 microns, from 10 microns to 60 microns, from 20 microns 70 microns, from 30 microns to 60 microns, or from 40 microns to 50 microns, or other ranges in the foregoing amounts. In terms of lower limits, the PSA layer may have a thickness of at least 8 microns, e.g., at least 12 microns, at least 20 microns, or at least 25 micros. In terms of upper limits, the polyolefin films may have a thickness less than 80 microns, e.g., less than 70 microns, less than 60 microns, or less than 50 microns.

The facestock layer can include, for example, glassine, kraft, and polyesters, such as polyethylene terephthalate (PET), polyamides (PA), polyethylene naphthalate (PEN), cotton, tissue, paper, fiberglass, synthetic textiles, and polyolefins, such as polypropylene (PP), ethylene-propylene copolymers, polyethylene (PE), and combinations thereof. Other polymeric film materials include urethane based polymers such as polyether urethane and polyester urethane; amide based polymers including polyether polyamide copolymers; acrylic based polymers including a polyacrylate, and ethylene/vinyl acetate copolymer; polyester based polymers including a polyether polyester; a vinyl chloride; a vinylidene chloride; a polystyrene; a polyacrylonitrile; a polycarbonate; a polyimide; ABS; polyacrylate; polycarbonate (PC); polyamide; polyimide (PI); polyamidoimide; polyacetal; polyphenylene oxide (PPO); polysulfone, polyethersulfone (PES); polyphenylene sulfide; polyether ether ketone (PEEK); polyetherimide (PE1); metallized polyethylene terephthalate (PET); polyvinyl fluoride (PVF); polyethylene ether (PEE); fluorinated ethylene propylene (FEP); polyurethane (PUR); liquid crystal polymers (LCPs, class of aromatic polyester); polyvinylidene fluoride (PVDF); aramid fibers; DIALAMY, (polymer alloys); polyethylene naphthalate (PEN); ethylene/tetrafluoroethylene; (E/TFE); polyphenyl sulfone (PPSU); and polymers or polymer alloys containing one or more of these materials.

The thickness or coating weight of the facestock layer may vary depending on the stiffness of the label desired for particular applications. The facestock layer according to certain embodiments of the present invention may comprise a thickness ranging from 100 microns to 1,000 microns, e.g., from 200 microns to 800 microns, from 150 microns to 500 microns, from 300 microns to 600 microns, or from 450 microns to 900 microns, or other ranges in the foregoing amounts. In terms of lower limits, the facestock layer may have a thickness of at least 100 microns, e.g., at least 150 microns, at least 200 microns, or at least 300 micros. In terms of upper limits, the polyolefin films may have a thickness less than 1000 microns, e.g., less than 800 microns, less than 500 microns, less than 400 microns, or less than 300 microns. In some embodiments, the facestock layer is 125 microns.

In some embodiments, the laminate composition comprises a topcoat layer disposed on the top of the facestock layer. The topcoat may enhance printing performance, durability and/or chemical resistance. In one embodiment, the topcoat layer of the label typically comprises a resin. Non-limiting examples of the resins that are suitable for use as topcoat include polyester-amino resin and a phenoxy resin, polyester-isocyanate, polyurethane, and polyacrylate. In some embodiments, the topcoat may possess one or more additional properties such as UV-resistance and anti-scratch property.

In some embodiments, the topcoat layer may also be configured to be receptive to printing. For example, the topcoat layer may comprise one or more printable layers containing an ink-receptive composition that is utilized to form the printable information. A variety of such compositions are known in the art, and these compositions generally include a binder and a pigment, such as silica or talc, dispersed in the binder. Optionally, the printable layer comprises a crosslinker CX-100 (DSM's polyfunctional aziridine liquid crosslinker). A number of such ink-receptive compositions are described in U.S. Pat. No. 6,153,288, the disclosure of which is hereby incorporated by reference. Printable information can be deposited on the facestock layer using various printing techniques, such as screen printing, dot-matrix, ink jet, laser printing, laser marking, thermal transfer, and so on. In some cases, the facestock layer is receptive to thermal transfer printing.

The inks used for printing on the topcoat layer may vary widely and may include commercially available water-based, solvent-based or radiation-curable inks Examples of these inks include Sun Sheen (a product of Sun Chemical identified as an alcohol dilutable polyamide ink), SUNTEX® MP (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink).

In some cases, the printable layer may be a layer that utilizes activatable inks, e.g., stimulus-activatable inks, such as (for example) laser-activated, pressure-activated, or temperature-activated inks.

The topcoat layer, in accordance with certain embodiments of the present invention, may be applied onto the facestock portion of the facestock layer by any known techniques in the art, such as spray, roll, brush, or other techniques. The printable layer can be formed by depositing, by gravure printing or the like, on the topcoat layer, with the bottom surface in contact with the top surface of the topcoat layer.

### Other (Optional) Components

In some cases, the PSA, the facestock layer, the topcoat layer, or the primer layer may optionally include one or more fillers, antioxidants, UV-absorbers, photo-stabilizers, and/or fillers. These additives may be incorporated into the adhesive in conventional quantities using conventional equipment and techniques. For example, representative fillers can include tale, calcium carbonate, organo-clay, glass fibers, marble dust, cement dust, feldspar, silica or glass, fumed silica, silicates, alumina, various phosphorus compounds, ammonium bromide, titanium dioxide, antimony trioxide, antimony trioxide, zinc oxide, zinc borate, barium sulfate, silicones, aluminum silicate, calcium silicate, glass microspheres, chalk, mica, clays, wollastonite, ammonium octamolybdate, intumescent compounds and mixtures of two or more of these materials. The fillers may also carry or contain various surface coatings or treatments, such as silanes, fatty acids, and the like. Still other fillers can include flame-retardant agents, such as the halogenated organic compounds. In certain embodiments, the topcoat layer may include one or more thermoplastic elastomers that are compatible with the other constituents of the layer, such as etherified melamine, hydroxylated polyester, polyester-melamine, and other suitable elastomers.

Optionally, the label disclosed herein comprises one or more primer layers and the one or more primer layers may be situated between the facestock layer and the adhesive layer.

### Liner

In some embodiments, the label further includes a liner deposited on the opposite side of the surface of the reactive adhesive layer that contacts the facestock layer. In some embodiments, the liner is a releasable liner. A releasable liner can be positioned adjacent to the reactive adhesive layer such that the reactive adhesive layer is disposed, or sandwiched, directly or indirectly between the bottom surface of facestock layer and the releasable liner. The releasable liner may function as a protective cover such that the release liner remains in place until the label is ready for attachment to an object. If a liner or release liner is included in the label, a wide array of materials and configurations can be used for the liner. In many embodiments, the liner is a paper or paper-based material. In many other embodiments, the liner is a polymeric film of one or more polymeric materials. Typically, at least one face of the liner is coated with a release material such as a silicone or silicone-based material. As will be appreciated, the release material-coated face of the liner is placed in contact with the otherwise exposed face of the adhesive layer. Prior to application of the label to a surface of interest, the liner is removed to thereby expose the adhesive face of the label. The liner can be in the form of a single sheet. Alternatively, the liner can be in the form of multiple sections or panels.

In some embodiments, the liner is a liner that allows for air egress. The air egress property is desirable to prevent the formation and trapping of air bubbles beneath the label. For example, the liner layer that allows for air egress may comprise ridges. In some cases, the top surface of the liner layer comprises ridges, so that channels in the bottom surface of the adhesive layer can be formed. In embodiments wherein the top surface of the liner layer comprises ridges and contacts the bottom surface of the adhesive layer, the ridges of the liner layer remain imprinted as channels in the bottom surface of the adhesive layer when the liner layer is removed during application. These channels may provide for air egress during application of the label to a substrate, as a result, flatness of application in appearance could be obtained. As discussed above, the planar design or layout of these ridges may vary widely.

The liner used in the label may have a thickness ranging from 20 microns to 150 microns, e.g., from 30 microns to 120 micron, from 60 microns to 100 micron, or from 50 microns to 90 micron. In terms of upper limits, the thickness of the label is less than 150 microns, e.g., less than 130 microns, or less than 100 microns. In terms of lower limits, the thickness of the label is greater than 20 microns, e.g., greater than 30 microns, or greater than 40 microns.

Various additives can also be added to one or more of the facestock layer, the primer layer, the adhesive layer, or liner layers to obtain a certain desired characteristic. These additives can include, for example, one or more waxes, surfactants, talc, powdered silicates, filler agents, defoamers, colorants, antioxidants, UV stabilizers, luminescents, crosslinkers, buffer agents, anti-blocking agents, wetting agents, matting agents, antistatic agents, acid scavengers, flame retardants, processing aids, extrusion aids, and others.

### Performance

The PSA of the present invention demonstrates an unexpected combination of high peel strength and superb static shear. Peel strength is the average force required to remove an adhesive laminated under specified conditions on a substrate, from the substrate at constant speed and at a specified angle. Peel strength can be assessed using methods well known in the art. In some embodiments, peel strength evaluations are performed according to the FINAT Test Method 1 (2019) (“FINAT-1”). The specimen comprising the PSA to be tested are prepared by cutting into strips of dimensions suitable for testing. For example, the strips may have a width of 50 mm and a minimum length of 175 mm. The backing material, if present, is removed before adhering the strips to clean test plates using a roller. Typically, at least three strips from each sample are tested at 20 minutes after the PSA is applied or 48 hours after the PSA is applied. For one test, let the strips affixed for 20 minutes, then position the test plate into the measuring device so that the angle of peel is 180° C. The test plate can be of any suitable material for evaluating peel strength. In some embodiments, the test plate comprises stainless steel. The peeling speed can be predetermined, e.g., 300 mm per minute, and the peeling force is recorded. Typically, a minimum of five readings at 10 mm intervals from the center section of each of the strips are recorded.

When peeling from stainless steel test panel, 20 minutes after the PSA is applied to the stainless steel, the PSA may demonstrate a peel strength from 1 N/inch to 30 N/inch on according to the FINAT-1 method, e.g., from 2 N/inch to 25 N/inch, from 3 N/inch to 20 N/inch, from 10 N/inch to 20 N/inch, from 5 N/inch to 18 N/inch, and from 9 N/inch to 15 N/inch, or about 13.7 N/inch. In terms of upper limits, the PSA demonstrated a peel strength of less than 25 N/inch, less than 20 N/inch, less than 18 N/inch, or less than 15 N/inch on stainless steel substrate after 20 minutes attachment. In terms of lower limits, the PSA demonstrated peel strength of greater than 1 N/inch, greater than 2 N/inch, greater than 5 N/inch, greater than 6 N/inch or greater than 7 N/inch, or greater than 8 N/inch on the stainless steel substrate

When peeling from stainless steel panel 48 hours after the PSA is applied to stainless steel, the PSA may demonstrate a peel strength from 10 N/inch to 40 N/inch on according to the FINAT-1 method, e.g., from 15 N/inch to 40 N/inch, from 18 N/inch to 35 N/inch, from 20 N/inch to 30 N/inch, or about 23 N/inch. In terms of upper limits, the PSA demonstrated a peel strength of less than 40 N/inch, less than 35 N/inch, or less than 30 N/inch. In terms of lower limits, the PSA demonstrated peel strength of greater than 15 N/inch, greater than 18 N/inch, greater than 20 N/inch on the stainless steel substrate.

The PSA of this disclosure also shows high static shear, indicating excellent cohesiveness. Static shear can be tested using methods well known in the art. In some embodiments, the test specimen comprising the PSA is centered on a test panel and applied to cover an area of 10 mm×10 mm without added pressure. The test panel can be produced from any material suitable for the static shear testing. In one embodiment, the test panel is a stainless steel panel. In some cases, aluminum foil is adhered to the facestock of the specimen to enhance the strength of the specimen of withstanding the 2 kg load. In some embodiments, the test specimen is adhered to the steel panel at ambient temperature for one day before a load of 2 kg is applied to the specimen. In some cases, e.g., when used in automobiles, it is desirable to test the static shear under a temperature above the ambient temperature, e.g., 80° C. Thus, in some cases, the specimen is affixed to the test panel without any pressure at 80° C. for 12 hours before a load of 2 kg is applied to the specimen and the static shear is measured. The weight of the load will gradually pull the specimen off the test panel. The duration of specimen, while it remains on the test panel are recorded. The longer the time the specimen remains on the panel, the greater the static shear the specimen possesses.

In some cases, the PSA demonstrates a static shear that ranges from 20 minutes to 2000 minutes, e.g., from 22 minutes to 1550 minutes, from 30 minutes to 500 minutes, or from 30 minutes to 400 minutes, when tested on stainless steel when tested at 80° C. In terms of lower limits, the static shear is greater than 20 minutes, greater than 22 minutes, greater than 30 minutes or greater than 60 minutes. In terms of upper limits, the static shear is lower than 2000 minutes, lower than 1550 minutes, or lower than 500 minutes.

### Adhesive Solution

This disclosure also provides an adhesive solution which comprises a solvent, a polyacrylate base polymer (typically in solution form, e.g., a polyacryate base polymer may comprise 30 wt. % solid and 65 wt. % solvent), a polyacrylate tackifier, a crosslinker package comprising an isocyanate crosslinker and an epoxy crosslinker as disclosed above. In some embodiments, the polyacrylate base polymer solution is Y1210, which has a solid content of 36 wt. %. In some embodiments the polyacrylate tackifier solution is 109A from Henkel, which has a solid content of 48 wt. %. The solvent that can be used to produce the PSA disclosed herein may be one or more solvents selected from the group consisting of toluene, ethyl acetate, isopropanol, xylene, n-hexane, n-heptane, methyl cyclohexane, butyl acetate, acetone, butanone, and 2-Acetoxy-1-methoxypropane.

The polyacrylate base polymer solution is present in an amount ranging from 60 wt. % to 90 wt. %, e.g., from 70 wt. % to 90 wt. %, from 75 wt. % to 85 wt. %, e.g., about 80 wt. %, based on the total weight of the pressure sensitive adhesive solution. In terms of upper limits, the PSA comprises polyacrylate base polymer solution in an amount of less than 90 wt. %, less than 85 wt. %, based on the total weight of the PSA solution. In terms of lower limits, the PSA solution comprises polyacrylate base polymer solution in an amount of greater than 70 wt. %, e.g., greater than 75 wt. %, based on the total weight of the PSA solution.

In some embodiments, the polyacrylate tackifier solution comprises solid content of polyacrylate tackifier that is present in an amount that ranges from 30 wt. % to 60 wt. %, e.g., from 40 wt. % to 55 wt. %, or about 48 wt. %. The polyacrylate tackifier solution is present in an amount ranging from 1 wt. % to 9 wt. %, e.g., from 3.8 wt. % to 9 wt. %, from 3 wt. % to 6 wt. %, or about 5 wt. %, based on the total weight of the pressure sensitive adhesive solution. In terms of upper limits, the PSA solution comprises polyacrylate tackifier solution in an amount of less than 9 wt. %, less than 8 wt. %, less than 6 wt. %, based on the total weight of the PSA solution. In terms of lower limits, the PSA solution comprises polyacrylate tackifier solution in an amount of greater than 1 wt. %, e.g., greater than 2 wt. %, based on the total weight of the PSA solution. In some embodiments, the polyacrylate tackifier solution is 109A, which comprises 48 wt. % solid content of the polyacrylate polymer.

The amount of solvent(s) used for producing the adhesive solution may vary depending on the desired viscosity that is suitable for coating on the substrate or other layers. Typically, the solvent is present in the adhesive solution in an amount ranging from 10 wt. % to 40 wt. %, e.g., from 8 wt. % to 45 wt. %, from 10 wt. % to 40 wt. %, from 15 wt. % to 25 wt. %, e.g., about 19 wt. %. In terms of lower limits, the solvent is present in an amount of greater than 5 wt. %, e.g., greater than 8 wt. %, greater than 10 wt. %, or greater than 12 wt. %, or greater than 15 wt. %, based on the total weight of the adhesive solution. In terms of upper limits, the solvent is present in an amount of less than 40 wt. %, less than 30 wt. %, or less than 25 wt. %, based on the total weight of the adhesive solution.

### Production of the PSA

The present invention also relates to methods of producing a PSA. The methods include dissolving in a solvent, a polyacrylate base polymer, a polyacrylate tackifier, a crosslinker package comprising an isocyanate and an epoxy to form an adhesive solution. Any of the aforementioned embodiments of the polyacrylate base polymer, acrylate tackifier, the cross-linkers can be used to produce an adhesive solution.

A variety of solvents can be used to dissolve the components of the PSA. Suitable solvents include those that demonstrate proper evaporation rate and in which the various components show good solubility. In preferred embodiments, the solvent is a petroleum-based solvent. Suitable solvents include but are not limited to, aromatic solvents, aliphatic solvents, ester solvents, xylene, ethyl benzene, isopropyl alcohol, and combinations thereof. Examples of aromatic solvents include aromatic rings with alkyl substitution (e.g. toluene). Examples of ester solvents include esters of 3 or more carbon atoms (e.g. methyl acetate, or ethyl acetate). In some embodiments, two or more solvents can be used to dissolve various components above to produce the adhesive solution.

The adhesive solution, as prepared above, has good coatability with a typical viscosity from 100 cps to 5,000 cps, e.g., from 200 cps to 4,000 cps, from 300 cps to 3,000 cps, from 400 cps to 2,000 cps, from 300 cps to 600 cps, or about 500 cps. In terms of lower limits, the viscosity is greater than 100, e.g., greater than 200 cps, greater than 300 cps, or greater than 400 cps. In terms of upper limits, the viscosity is less than 5,000 cps, less than 4,000 cps, less than 2,000 cps, less than 1,000 cps. Methods for measuring viscosity are well known, for example using the Brookfield Viscometer method, testing the flow resistance of the fluid by low and medium rate rotation.

The adhesive solution can be coated to a facestock using methods that are well known for solvent based adhesives, for example, as disclosed in Manufacturing Pressure-Sensitive Adhesive Products: A Coating and Laminating Process, available at adhesivesmag.com/articles/86079-manufacturing-pressure-sensitive-adhesive-products-a-coating-and-laminating-process, the content of which is hereby incorporated by reference in its entirety. The facestock that has been coated with the wet adhesive is then baked at a temperature to allow the solvent to evaporate. Preferably, the drying temperature for drying is lower than the curing triggering temperature to prevent crosslinking from occurring during the drying process.

In some embodiments, the coating is performed by direct coating, in which the pressure-sensitive adhesive is coated directly onto the facestock or backing material and dried to produce a label. In some embodiments, the coating is performed by transfer coating, in which the adhesive is first coated onto a release liner (as described above), and dried. The dried adhesive/liner is then laminated with a facestock.

In some embodiments, the adhesive solution as produced above can then be coated onto a facestock or a release liner using a solvent coater by knife over roll, slot die, or comma coating. The solution may be coated to form an adhesive layer having a coat weight of at least 5 grams per square meter (gsm), e.g., at least 10 gsm or at least 15 gsm. In terms of upper limits, the solution may be coated to form an adhesive layer having a coat weight of 80 gsm or less, e.g., 50 gsm or less, or 40 gsm or less. In terms of ranges, the solution may be coated to form an adhesive layer having a coat weight from 5 gsm to 60 gsm, e.g., from 10 gsm to 50 gsm or from 15 gsm to 40 gsm, depending on the end use of the adhesive layer. The facestock/liner coated with the solution above then can be dried as further described below and processed into labels. In some cases, it is used as a transfer adhesive without being associated with a facestock.

The coating process is typically performed in an oven having multiple temperature zones, e.g., at least 2 zones, at least 3 zones, at least four zones, at least five zones, or at least six zones. The temperature zones may range from 30° C. to 200° C., e.g., from 40° C. to 150° C. or from 60° C. to 130° C. The temperature may increase from the first to last zone, though multiple zones may be at the same temperature.

Once coated, the adhesive may be dried in an oven, for a predetermined drying time. The drying oven can have a temperature of greater than 100° C. The rate of solvent evaporation increases with temperature. The drying time can be at least 2 minutes, at least 4 minutes, at least 6 minutes, at least 8 minutes, at least 10 minutes, at least 15 minutes, at least 20 minutes, at least 25 minutes, at least 30 minutes, at least 40 minutes, at least 50 minutes, or at least 1 hour.

In some embodiments, the adhesive is laminated onto a liner. Suitable liners are described above.

### Labeling Articles

The present invention also relates to methods of applying a label comprising the PSA to an article. The present invention also provides labeled articles. The methods include providing an article defining an outer surface, and a label in accordance with an embodiment. The methods further include affixing the label to the outer surface of the article, thereby applying the label to the article.

The labels can be affixed to the articles in a batch, continuous, or semi-continuous fashion. Prior to application, one or more liners can be removed from the labels to thereby expose the adhesive face of the labels. The adhesive face and label is then contacted with the container(s) or article(s) and the labels applied thereto. Adhering may also include one or more operations of pressing or otherwise applying a pressing force against the label to promote contact and/or adhesion with the container; activating and/or curing of the adhesive such as by heating and/or exposure to UV light; and/or drying operations.

### Adhesive System

Typically, when in storage, the solution containing the polyacrylate base polymer, optionally also the polyacrylate tackifier, is kept separate from the crosslinkers to prevent undesired crosslinking. The crosslinkers can be added to the solution containing the polyacrylate base polymer immediately prior to the producing of the adhesive and/or the labels. Thus, also provided is an adhesive system comprising: a) a polycrylate base polymer, and optionally a polyacrylate tackifier; b) a crosslinker package comprising an epoxy crosslinker and an isocyanate crosslinker; and the crosslinkers are separate from the polyacrylate base polymer.

The materials in the adhesive system may be present in the amounts such that the PSAs produced have the properties described in this disclosure.

### Embodiments

This invention is further illustrated by the following exemplary embodiments.

Embodiment 1: A pressure sensitive adhesive comprising: a polyacrylate base polymer comprising acid groups and hydroxyl groups, a crosslinker package comprising: an isocyanate crosslinker, and an epoxy crosslinker, and a polyacrylate tackifier.

Embodiment 2: The pressure sensitive adhesive of embodiment 1, wherein the weight ratio of the polyacrylate tackifier to epoxy ranges from 35:1 to 131:1.

Embodiment 3: The pressure sensitive adhesive of any of embodiments 1-2, wherein weight ratio between the isocyanate crosslinker to the epoxy crosslinker ranges from 0.16:1 to 62:1.

Embodiment 4: The pressure sensitive adhesive of embodiment 1, further comprising a non-acrylate tackifier (e.g., a non-polyacrylate tackifier).

Embodiment 5: The pressure sensitive adhesive of embodiment 1, wherein the non-acrylate tackifier a terpene phenolic resin.

Embodiment 6: The pressure sensitive adhesive of embodiment 1, wherein the epoxy has an epoxide equivalent weight (EEW) ranging from 70 g/eq to 220 g/eq.

Embodiment 7: The pressure sensitive adhesive of any of embodiments 1-2, wherein the amount of the isocyanate crosslinker is greater than the amount of epoxy.

Embodiment 8: The pressure sensitive adhesive of any of embodiments 1-7, wherein the isocyanate crosslinker is present in an amount ranging from 0.1 wt. % to 10 wt %, based on total solid weight of the pressure sensitive adhesive.

Embodiment 9: The pressure sensitive adhesive of any of embodiments 1-8, wherein the epoxy crosslinker is present in an amount ranging from 0.02 wt. % to 0.6 wt. %, based on total solid weight of the pressure sensitive adhesive.

Embodiment 10: The pressure sensitive adhesive of any of embodiments 1-3, wherein the pressure sensitive adhesive demonstrates a 20 min 180 peel strength ranging at least 8 N/inch on stainless steel, as measured according to FINAT-1 method.

Embodiment 11: The pressure sensitive adhesive of any of embodiments 1-10, wherein the pressure sensitive adhesive demonstrates a static shear of at least 20 min, when tested on an area of 0.5 inch×0.5 inch at 80° C. and under a 2 kg load.

Embodiment 12: The pressure sensitive adhesive of any of embodiments 1-11, wherein the polyacrylate tackifier has an acid value ranging from 5 mgKOH/g to 100 mgKOH/g.

Embodiment 13: The pressure sensitive adhesive of any of embodiments 1-12, wherein the polyacrylate base polymer has a molecular weight ranging from 50,000 g/mol to 1,500,000 g/mol.

Embodiment 14: The pressure sensitive adhesive of any of embodiments 1-12, wherein the acid value of the polyacrylate base polymer ranges from 2 mgKOH/g to 90 mgKOH/g.

Embodiment 15: The pressure sensitive adhesive of any of embodiments 1-14, wherein the hydroxyl value of the polyacrylate base polymer ranges from 1 mgKOH/g to 50 mgKOH/g.

Embodiment 16: The pressure sensitive adhesive of any of embodiments 1-15, wherein the polyacrylate tackifier has a molecular weight that ranges from 10,000 g/mol to 280,000 g/mol.

Embodiment 17: The pressure sensitive adhesive of any of embodiments 1-16, wherein the polyacrylate tackifier has a T_{g} that ranges from −30° C. to 40° C.

Embodiment 18: The pressure sensitive adhesive of any of embodiments 1-17, wherein the polyacrylate tackifier is present in an amount ranging from 0.5 wt. % to 45 wt. % based on total solid weight of the pressure sensitive adhesive.

Embodiment 19: The pressure sensitive adhesive of any of embodiments 1-18, wherein the weight ratio of the polyacryate base polymer to the polyacrylate tackifier ranges from 4.6:1 to 80:1.

Embodiment 20: The pressure sensitive adhesive of any of embodiments 1-19, wherein the acid value of the polyacrylate base polymer ranges from 10 mgKOH/g to 50 mgKOH/g and the OHV of the polyacrylate base polymer ranges from 5 mgKOH/g-20 mgKOH/g, wherein the isocyanate crosslinker is present in an amount ranging from 1-6 wt. % based on total solid weight of the pressure sensitive adhesive, wherein the epoxy crosslinker is present in an amount ranging from 0.1 wt. % to 0.6 wt. % based on total solid weight of the pressure sensitive adhesive, wherein the polyacrylate tackifier is present in an amount ranging from 4 wt. % to 25 wt. % based on total solid weight of the pressure sensitive adhesive, wherein the weight ratio of the polyacrylate tackifier to epoxy ranges from 35:1 to 131:1, wherein the pressure sensitive adhesive demonstrates a 20 min 180 peel strength of at least 12 N/inch on stainless steel, as measured according to FINAT-1 method, and wherein the pressure sensitive adhesive demonstrates a static shear at least 20 min, when tested on an area of 0.5 inch×0.5 inch at 80° C. and under a 2 kg load.

Embodiment 21: The pressure sensitive adhesive of embodiment 1-20, wherein the acid value of the polyacrylate base polymer ranges from 10 mgKOH/g to 50 mgKOH/g and the OHV of the polyacrylate base polymer ranges from 5 mgKOH/g to 20 mgKOH/g, wherein the isocyanate crosslinker is present in an amount of 1 wt. % to 6 wt. % based on total solid weight of the pressure sensitive adhesive, wherein the epoxy crosslinker is present in an amount ranging from 0.1 wt. % to 0.6 wt. % based on total solid weight of the pressure sensitive adhesive, wherein the polyacrylate tackifier is present in an amount ranging from 4 wt. % to 25 wt. % based on total solid weight of the pressure sensitive adhesive, wherein the weight ratio of the polyacrylate tackifier to epoxy ranges from 35:1 to 131:1, wherein the polyacrylate tackifier has an acid value ranging from 50 mgKOH/g to 75 mgKOH/g, wherein the pressure sensitive adhesive demonstrates a 20 min 180 peel strength of at least 12 N/inch on stainless steel, as measured according to FINAT-1 method, and wherein the pressure sensitive adhesive demonstrates a static shear at least 20 min, when tested on an area of 0.5 inch×0.5 inch at 80° C. and under a 2 kg load.

Embodiment 22: The pressure sensitive adhesive of any of embodiments 1-21, wherein the acid value of the polyacrylate base polymer ranges from 10 mgKOH/g to 50 mgKOH/g and the OHV of the polyacrylate base polymer ranges from 5 mgKOH/g to 20 mgKOH/g, wherein the isocyanate crosslinker is present in an amount ranging from 1 wt. % to 6 wt. % based on total solid weight of the pressure sensitive adhesive, wherein the epoxy crosslinker is present in an amount ranging from 0.1 wt. % to 0.6 wt. % based on total solid weight of the pressure sensitive adhesive, wherein the polyacrylate tackifier is present in an amount ranging from 4 wt. % to 25 wt. % based on total solid weight of the pressure sensitive adhesive, and wherein the polyacrylate tackifier has a molecular weight of 90,000 g/mol to 220,000 g/mol and has a T_{g} of −15° C. to −8° C.

Embodiment 23: A laminate composition comprising a liner layer and a pressure sensitive adhesive layer, wherein the pressure sensitive layer comprises the pressure sensitive adhesive of any one of embodiments 1-22.

Embodiment 24: The laminate composition of embodiment 23, wherein the liner is an embossed liner.

Embodiment 25: A laminate composition comprising a facestock layer and a pressure sensitive adhesive layer comprising the pressure sensitive adhesive of any one of embodiments 1-22.

Embodiment 26: The laminate composition of embodiment 25, wherein the facestock layer is a film comprising one or more resins selected from the group consisting of polyester, ABS, polyacrylate, polycarbonate (PC), polyamide, polyimide (PI), polyamidoimide, polyacetal, polyphenylene oxide (PPO), polysulfone, polyethersulfone (PES), polyphenylene sulfide, polyether ether ketone (PEEK), polyetherimide (PE1), metallized polyethylene terephthalate (PET), polyvinyl fluoride (PVF), polyethylene ether (PEE), fluorinated ethylene propylene (FEP), polyurethane (PUR), liquid crystal polymers (LCPs, class of aromatic polyester), polyvinylidene fluoride (PVDF), aramid fibers, DIALAMY, (polymer alloys), polyethylene naphthalate (PEN), ethylene/tetrafluoroethylene, (E/TFE), polyphenyl sulfone (PPSU).

Embodiment 27: The laminate composition of any of embodiments 23-26, wherein the laminate further comprises a topcoat layer disposed on top of the facestock layer.

Embodiment 28: The laminate composition of any of embodiments 23-27, wherein the laminate is disposed in the form of a flat layer, and wherein the flat layer has a thickness ranging from 8 μm to 80 μm.

Embodiment 29: A label comprising the pressure sensitive adhesive of any of embodiments 1-22, or the laminate composition of embodiments 23-28.

Embodiment 30: A method for producing a pressure sensitive adhesive comprising:
dissolving in a solvent a) a polycrylate base polymer; b) an isocyanate and an epoxy; and c) a polyacrylate tackifier to produce a pressure sensitive adhesive solution.

Embodiment 31: The method of embodiment 30, wherein the polyacrylate tackifier has an acid value ranging from 5 mgKOH/g to 100 mgKOH/g.

Embodiment 32: The method of any of embodiments 30-31, wherein the solvent is selected from the group consisting of toluene, ethyl acetate, isopropanol, xylene, n-hexane, n-heptane, methyl cyclohexane, butyl acetate, acetone, butanone, and 2-Acetoxy-1-methoxypropane.

Embodiment 33: The method of embodiments 30-32, wherein the acid value of the polyacrylate base polymer ranges from 2 mgKOH/g to 90 mgKOH/g.

Embodiment 34: The method of any of embodiments 30-33, wherein the OHV of the polyacrylate base polymer ranges from 1 mgKOH/g to 50 mgKOH/g.

Embodiment 35: The method of any of embodiments 30-34, wherein the polyacrylate tackifier has a molecular weight of lower than 280,000 g/mol.

Embodiment 36: The method of any of embodiments 30-35, wherein the polyacrylate tackifier has a T_{g} higher than −30° C.

Embodiment 37: The method of any of embodiments 30-36, wherein acid value of the polyacrylate tackifier ranges from 5 mgKOH/g to 100 mgKOH/g.

Embodiment 38: The method of any of embodiments 30-37, the epoxide equivalent of the epoxy crosslinker ranges from 70 g/eq to 220 g/eq.

Embodiment 39: The method of any of embodiments 30-38, wherein the method further comprises the step of coating a facestock with the PSA solution, and drying the pressure sensitive adhesive solution to produce a label.

Embodiment 40: The method of any of embodiments 30-38, wherein the method further comprises the step of coating a release liner with the pressure sensitive adhesive solution, drying the pressure sensitive adhesive solution on release liner to produce a dried PSA/liner composition, and applying the dried PSA/liner composition to a facestock to produce a label.

Embodiment 41: A pressure sensitive adhesive solution comprises: a polyacrylate base polymer solution, an isocyanate crosslinker, an epoxy crosslinker, a polyacrylate tackifier, and a solvent.

Embodiment 42: The pressure sensitive adhesive solution of embodiment 40, wherein the solvent is selected from the group consisting of toluene, ethyl acetate, isopropanol, xylene, n-hexane, n-heptane, methyl cyclohexane, butyl acetate, acetone, butanone, and 2-Acetoxy-1-methoxypropane.

### Examples

The following examples are offered to illustrate, but not to limit the claimed invention.

### Procedure I

Three exemplary PSAs were prepared by mixing ingredients listed in Table 1 in toluene to produce PSA solutions. Each of the PSA solutions was coated on a liner to dry. After drying, the liner was peeled off, and the dry PSA was transferred to a 100 micro polyvinyl chloride (PVC) facestock to form a laminate. The peel strength and static shear of the PSA were evaluated as described below. The results are shown in Table 1. All percentages are solid weight percentage based on total solid weight of the PSA.

The various performance tests deployed in Procedures I and II are described below. To test peel strength, the laminate comprising the PSA was cut into strips of 50 mm wide by 175 mm long. The release liners were peeled off the strips. The strips were bonded to the test plate by a single back-and-forth pass with a 2 kg roller. Twenty minutes after attachment, the peel strength (N/20 mm wide) was measured following FINAT-1 test protocol at ambient temperature and a relative humidity of 50%. The measurements were obtained by using a tensile strength testing machine at a pull rate of 300 mm/min and a pull angle of 180°. The peel force at a minimum of five readings at 10 mm intervals from the center of the each strip was recorded. The average of the five readings were reported as the peel strength for the PSA.

The static shear of the examples was evaluated as follows. A white painted steel panel was cleaned so that it was free of stains, discoloration, or scratches. During the whole procedure, caution was taken to avoid contacting the surface of the panel with fingers. The test specimens comprising the PSAs were centered on test panel. The specimens were applied without added pressure to cover an area that is 0.5 inch long and 0.5 inch wide. Aluminum foil was applied on the specimen to enhance the strength of the specimen, such that the specimen can withstand a high load, e.g., a 2 kg load, without cracking. The specimens were left on the steel panel at 80° C. for one day before applying a load of 2 kg on the specimen at 80° C. The relative humidity during the test was 50%. The duration time of specimen on the steel panel before it detached from the panel was recorded for each specimen. Various detachment modes were observed and recorded, cohesion failure mode (“CF”) refers to that the specimen left residues of adhesive on both the facestock of the label and also the test panel after detachment. Clean panel (“CP”) refers to that the specimen does not leave any residue of adhesive on the test panel after detachment. Adhesive transfer (“AF”) refers to that the adhesive is transferred to the panel after detachment.

TABLE 1
Effects of polyacrylate tackifier and crosslinker amounts

| Ingredients | Ex. 1 | Ex. 2 | Ex. 3 | Comp. A | Comp. B | Comp. C | Comp. D |
|---|---|---|---|---|---|---|---|
| Y-1210 (base polymer) | 76.95 | 82.60 | 67.86 | 70.89 | 84.57 | 69.07 | 76.95 |
| 109A (acrylate tackifier | 8.62 | 6.00 | 17.5 | 15.88 | 1.00 | 18.5 | 8.62 |
| (e.g., polyacrylate tackifier)) | | | | | | | |
| TP96 (non-acrylate | 9.77 | 7.00 | 9.77 | 9.00 | 9.77 | 9.77 | 9.66 |
| tackifier (e.g., polyacrylate | | | | | | | |
| tackifier)) | | | | | | | |
| Isocyanate crosslinker | 4.52 | 4.26 | 4.52 | 4.17 | 4.52 | 4.52 | 4.52 |
| (From Covestro) | | | | | | | |
| Epoxy crosslinker | 0.14 | 0.14 | 0.35 | 0.07 | 0.14 | 0.14 | 0.25 |
| (From Yasusa chemical) | | | | | | | |
| Isocyanate: epoxy | 32.29:1 | 30.42:1 | 12.91:1 | 59.57:1 | 32.28 | 32.28 | 18.08 |
| weight ratio | | | | | | | |
| Tackifier: epoxy | 61.57:1 | 42.86:1 | 50:1 | 227:1 | 7.14:1 | 132:1 | 34.48 |
| crosslinker weight ratio | | | | | | | |
| 180° peel | 13.7/CP | 14/CP | 18.1/CP | 16/CP | 13.1/CP | 17.2/CP | 14.1/CP |
| (N/inch) 20 min | | | | | | | |
| 180° peel | 23/CP | 20/CP | 23.4/CP | 24/CP | 20/CP | 25/CP | 21.3/CP |
| (N/inch) 48 hr | | | | | | | |
| Static shear | >30 min/CF | 20-30 min/CF | 25 min/CP | 5 min/CF | 2 min/CP | 3 min/CF | 10 min/CP |
| 0.5 inch*0.5 inch | | | | | | | |
| 2 kg @ 80° C. | | | | | | | |

As shown in Table 1, Examples 1-3 all demonstrated high static shear values—at least 20 min with either a CF or CP failure. These Examples also demonstrated good peel strength values—at least 13.7/CP in a 20 min 180° peel strength test and at least 20/CP in a 48 hour 180° peel strength test.

In contrast, the Comparative Examples A-D, although demonstrating adequate peel strength values, demonstrated poor static shear values—in 10 minutes or less. The laminates comprising the PSAs were detached from the test panels. The difference may be attributed to the fact that for Examples 1-3, the ratios of the polyacrylate tackifier to the epoxy crosslinker were within the range of 35:1 to 131:1. The utilization of this range unexpectedly provides for a desirable balance of cohesion and adhesion (tack) properties of the PSA. In contrast, the ratios of the polyacrylate tackifier to the epoxy crosslinker in the Comparative Examples were either too high, e.g., Comp. A and Comp. C, or too low, e.g., Comp. B and Comp. D. These results show the unexpected importance of maintaining the weight ratio of the polyacrylate tackifier to the epoxy crosslinker within the aforementioned ranges to produce PSAs with the desirable balance of cohesion and tack properties.

Additional exemplary PSAs (Ex. 4-7 and Comp. E) were produced using ingredients in Table 2. Laminates comprising the PSAs were produced and tested for performance using the procedures as described above.

TABLE 2
Effects of the polyacrylate tackifiers having varying T_{g}

| Ingredients(on solid weight) | Ex. 4 | Ex. 5 | Ex. 6 | Ex. 7 | Comp. E |
|---|---|---|---|---|---|
| Y-1210(base polymer)(From Yasusa) | 81.51 | 81.51 | 81.51 | 81.51 | 81.51 |
| Y-1220(polyacrylate tackifier)) | 8.00 | | | | |
| T_{g}: −25° C.(From Yasusa) | | | | | |
| 247A (polyacrylate tackifier)) | | 8.00 | | | |
| T_{g}: −10° C.(From Henkel) | | | | | |
| Neocryl B-804 (polyacrylate tackifier)) | | | 8.00 | | |
| T_{g}: 33° C.(From DSM) | | | | | |
| BM141 (polyacrylate tackifier)) | | | | 8.00 | |
| T_{g}: 37° C.(From Pioneer) | | | | | |
| Neocryl BM722 (polyacrylate tackifier) | | | | | 8.00 |
| T_{g}: 43° C.(From DSM) | | | | | |
| TP96 (non-acrylate tackifier) | 6.00 | 6.00 | 6.00 | 6.00 | 6.00 |
| Isocyanate crosslinker (from MISUI) | 4.36 | 4.36 | 4.36 | 4.36 | 4.36 |
| Epoxy crosslinker(From Synasia) | 0.13 | 0.13 | 0.13 | 0.13 | 0.13 |
| Isocyanate:epoxy weight ratio | 33.54:1 | 33.54:1 | 33.54:1 | 33.54:1 | 33.54:1 |
| Tackifier:epoxy crosslinker weight ratio | 61.54:1 | 61.54:1 | 61.54:1 | 61.54:1 | 61.54:1 |
| 180° peel (N/inch)20 min | 15/CP | 19.2/CP | 17/CP | 18/CP | 15/CP |
| 180° peel (N/inch)48 hr | 17/CP | 24/CP | 23/CP | 22/CP | 21/CP |
| Static shear 0.5 inch*0.5 inch 2 kg @80° C. | 20 min/CF | 25 min/CF | >30 min/CP | 20 min/CP | 5 min/CP |

The results in Table 2 show that the T_{g} of tackifier can affect the performance of the PSAs. In general, the PSAs comprising acrylate tackifiers with a T_{g} less than 43° C. (Ex. 4 to Ex. 7) showed acceptable static shear. The general trend is that the static shear value increased as the T_{g} of the polyacrylate tackifier increased (see the Ex. 4 to Ex. 6), and the static shear reached a peak value of greater than 30 min/CP when the T_{g} was 33° C. (Ex. 6). The static shear value decreased when the T_{g} increased to above 33° C. When the T_{g} of the polyacrylate tackifier was as high as 43° C. (Comp. E), the static shear of the PSA was very low (5 min/CP), rendering the PSA unsuitable for use in most applications. The peel strength values of all examples (including Ex. 4-6 and Comp. E) were found to be acceptable. Peel strength is also an indication of wetting property of the PSA. These results indicate that it is desirable to select a polyacrylate tackifier with a T_{g} within a suitable range (e.g., between −30° C. and 42° C.) in order to maintain the balanced properties of good cohesion, adhesion and wetting property of the PSA.

The invention has been described in detail, modifications within the spirit and scope of the invention will be readily apparent to those of skill in the art. In view of the foregoing discussion, relevant knowledge in the art and references discussed above in connection with the Background and Detailed Description are all incorporated herein by reference. In addition, it should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriate combined with other embodiments as will be appreciated by one of skill in the art. Furthermore, those of ordinary skill in the art will appreciate that the foregoing description is by way of example only, and is not intended to limit the invention.

1. A pressure sensitive adhesive comprising:
a polyacrylate base polymer comprising acid groups and hydroxyl groups,
a crosslinker package comprising:
an isocyanate crosslinker, and
an epoxy crosslinker, and
a polyacrylate tackifier.

2. The pressure sensitive adhesive of claim 1, wherein the weight ratio of the polyacrylate tackifier to epoxy ranges from 35:1 to 131:1.

3. The pressure sensitive adhesive of claim 1, wherein weight ratio between the isocyanate crosslinker to the epoxy crosslinker ranges from 0.16:1 to 62:1.

4. The pressure sensitive adhesive of claim 1 further comprising a non-acrylate tackifier.

5. The pressure sensitive adhesive of claim 1, wherein the non-acrylate tackifier is a terpene phenolic resin.

6. The pressure sensitive adhesive of claim 1, wherein the epoxy has an epoxide equivalent weight (EEW) ranging from 70 g/eq to 220 g/eq.

7. The pressure sensitive adhesive of claim 1, wherein the amount of the isocyanate crosslinker is greater than the amount of epoxy.

8. The pressure sensitive adhesive of claim 1, wherein the isocyanate crosslinker is present in an amount ranging from 0.1 wt. % to 10 wt %, based on the total solid weight of the pressure sensitive adhesive.

9. The pressure sensitive adhesive of claim 1, wherein the epoxy crosslinker is present in an amount ranging from 0.02 wt. % to 0.6 wt. %, based on the total solid weight of the pressure sensitive adhesive.

10. The pressure sensitive adhesive of claim 1, wherein the pressure sensitive adhesive demonstrates a 20 min 180° peel strength ranging from 1 N/inch to 30 N/inch on stainless steel, as measured according to the FINAT-1 method.

11. The pressure sensitive adhesive of claim 1, wherein the pressure sensitive adhesive demonstrates a static shear of at least 20 min, when tested on an area of 0.5 inch×0.5 inch at 80° C. and with a 2 kg load.

12. The pressure sensitive adhesive of claim 1, wherein the polyacrylate tackifier has an acid value ranging from 5 mgKOH/g to 100 mgKOH/g.

13. The pressure sensitive adhesive of claim 1, wherein the polyacrylate base polymer has a molecular weight ranging from 50,000 g/mol to 1,500,000 g/mol.

14. The pressure sensitive adhesive of claim 1, wherein the acid value of the polyacrylate base polymer ranges from 2 mgKOH/g to 90 mgKOH/g.

15. The pressure sensitive adhesive of claim 1, wherein the hydroxyl value of the polyacrylate base polymer ranges from 1 mgKOH/g to 50 mgKOH/g.

16. The pressure sensitive adhesive of claim 1, wherein the polyacrylate tackifier has a molecular weight that ranges from 10,000 g/mol to 280,000 g/mol.

17. The pressure sensitive adhesive of claim 1, wherein the polyacrylate tackifier has a T_{g} that ranges from −30° C. to 42° C.

18. The pressure sensitive adhesive of claim 1, wherein the polyacrylate tackifier is present in an amount ranging from 0.5 wt. % to 45 wt. % based on the total solid weight of the pressure sensitive adhesive.

19. The pressure sensitive adhesive of claim 1, wherein the weight ratio of the polyacryate base polymer to the polyacrylate tackifier ranges from 4.6:1 to 80:1.

20. The pressure sensitive adhesive of claim 1,
wherein the acid value of the polyacrylate base polymer ranges from 10 mgKOH/g to 50 mgKOH/g and the OHV of the polyacrylate base polymer ranges from 5 mgKOH/g-20 mgKOH/g,
wherein the isocyanate crosslinker is present in an amount ranging from 1-6 wt. % based on total solid weight of the pressure sensitive adhesive, wherein the epoxy crosslinker is present in an amount ranging from 0.1 wt. % to 0.6 wt. % based on total solid weight of the pressure sensitive adhesive,
wherein the polyacrylate tackifier is present in an amount ranging from 4 wt. % to 25 wt. % based on the total solid weight of the pressure sensitive adhesive,
wherein the weight ratio of the polyacrylate tackifier to epoxy ranges from 35:1 to 131:1,
wherein the pressure sensitive adhesive demonstrates a 20 min 180 peel strength of at least 12 N/inch on stainless steel, as measured according to FINAT-1 method, and
wherein the pressure sensitive adhesive demonstrates a static shear at least 20 min, when tested on an area of 0.5 inch×0.5 inch at 80° C. and under a 2 kg load.

21. The pressure sensitive adhesive of claim 1,
wherein the acid value of the polyacrylate base polymer ranges from 10 mgKOH/g to 50 mgKOH/g and the OHV of the polyacrylate base polymer ranges from 5 mgKOH/g to 20 mgKOH/g, wherein the isocyanate crosslinker is present in an amount of 1 wt. % to 6 wt. % based on the total solid weight of the pressure sensitive adhesive,
wherein the epoxy crosslinker is present in an amount ranging from 0.1 wt. % to 0.6 wt. % based on total solid weight of the pressure sensitive adhesive,
wherein the polyacrylate tackifier is present in an amount ranging from 4 wt. % to 25 wt. % based on total solid weight of the pressure sensitive adhesive,
wherein the weight ratio of the polyacrylate tackifier to epoxy ranges from 35:1 to 131:1
wherein the polyacrylate tackifier has an acid value ranging from 50 mgKOH/g to 75 mgKOH/g,
wherein the pressure sensitive adhesive demonstrates a 20 min 180 peel strength of at least 12 N/inch on stainless steel, as measured according to FINAT-1 method, and
wherein the pressure sensitive adhesive demonstrates a static shear at least 20 min, when tested on an area of 0.5 inch×0.5 inch at 80° C. and under a 2 kg load.

22. The pressure sensitive adhesive of claim 1,
wherein the acid value of the polyacrylate base polymer ranges from 10 mgKOH/g to 50 mgKOH/g and the OHV of the polyacrylate base polymer ranges from 5 mgKOH/g to 20 mgKOH/g,
wherein the isocyanate crosslinker is present in an amount ranging from 1 wt. % to 6 wt. % based on total solid weight of the pressure sensitive adhesive,
wherein the epoxy crosslinker is present in an amount ranging from 0.1 wt. % to 0.6 wt. % based on total solid weight of the pressure sensitive adhesive,
wherein the polyacrylate tackifier is present in an amount ranging from 4 wt. % to 25 wt. % based on total solid weight of the pressure sensitive adhesive, and
wherein the polyacrylate tackifier has a molecular weight of 90,000 g/mol to 220,000 g/mol and has a T_{g} of −15° C. to −8° C.

23. A laminate composition comprising a liner layer and a pressure sensitive adhesive layer, wherein the pressure sensitive layer comprises the pressure sensitive adhesive of claim 1.

24. The laminate composition of claim 23, wherein the liner is an embossed liner.

25. A laminate composition comprising a facestock layer and a pressure sensitive adhesive layer comprising the pressure sensitive adhesive of claim 1.

26. The laminate composition of claim 25, wherein the facestock layer is a film comprising one or more resins selected from the group consisting of polyester, ABS, polyacrylate, polycarbonate (PC), polyamide, polyimide (PI), polyamidoimide, polyacetal, polyphenylene oxide (PPO), polysulfone, polyethersulfone (PES), polyphenylene sulfide, polyether ether ketone (PEEK), polyetherimide (PEI), metallized polyethylene terephthalate (PET), polyvinyl fluoride (PVF), polyethylene ether (PEE), fluorinated ethylene propylene (FEP), polyurethane (PUR), liquid crystal polymers (LCPs, class of aromatic polyester), polyvinylidene fluoride (PVDF), aramid fibers, DIALAMY, (polymer alloys), polyethylene naphthalate (PEN), ethylene/tetrafluoroethylene, (E/TFE), polyphenyl sulfone (PPSU).

27. The laminate composition of claim 23, wherein the laminate further comprises a topcoat layer disposed on top of the facestock layer.

28. The laminate composition of claim 23, wherein the laminate is disposed in the form of a flat layer, and wherein the flat layer has a thickness ranging from 8 μm to 80 μm.

29. A label comprising the pressure sensitive adhesive of claim 1.

30. A method for producing a pressure sensitive adhesive comprising:
dissolving in a solvent
a) a polycrylate base polymer;
b) an isocyanate and an epoxy; and
c) a polyacrylate tackifier
to produce a pressure sensitive adhesive solution.

31. The method of claim 30, wherein the polyacrylate tackifier has an acid value ranging from 5 mgKOH/g to 100 mgKOH/g.

32. The method of claim 30, wherein the solvent is selected from the group consisting of toluene, ethyl acetate, isopropanol, xylene, n-hexane, n-heptane, methyl cyclohexane, butyl acetate, acetone, butanone, and 2-Acetoxy-1-methoxypropane.

33. The method of claim 30, wherein the acid value of the polyacrylate base polymer ranges from 2 mgKOH/g to 90 mgKOH/g.

34. The method of claim 30, wherein the OHV of the polyacrylate base polymer ranges from 1 mgKOH/g to 50 mgKOH/g.

35. The method of claim 30, wherein the polyacrylate tackifier has a molecular weight of lower than 280,000 g/mol.

36. The method of claim 30, wherein the polyacrylate tackifier has a T_{g} higher than −30° C.

37. The method of claim 30, wherein acid value of the polyacrylate tackifier ranges from 5 mgKOH/g to 100 mgKOH/g.

38. The method of claim 30, the epoxide equivalent of the epoxy crosslinker ranges from 70 g/eq to 220 g/eq.

39. The method of claim 30, wherein the method further comprises the step of coating a facestock with the PSA solution, and drying the pressure sensitive adhesive solution to produce a label.

40. The method of claim 30, wherein the method further comprises the step of coating a release liner with the pressure sensitive adhesive solution, drying the pressure sensitive adhesive solution on release liner to produce a dried PSA/liner composition, and applying the dried PSA/liner composition to a facestock to produce a label.

41. A pressure sensitive adhesive solution comprises:
a polyacrylate base polymer solution,
an isocyanate crosslinker, an epoxy crosslinker,
a polyacrylate tackifier, and
a solvent.

42. The pressure sensitive adhesive solution of claim 41, wherein the solvent is selected from the group consisting of toluene, ethyl acetate, isopropanol, xylene, n-hexane, n-heptane, methyl cyclohexane, butyl acetate, acetone, butanone, and 2-Acetoxy-1-methoxypropane.

43. A label comprising the laminate composition of claim 23.
